(19) United States
(12) Patent Application Publication
(10) Pub. No.: US 2017/0084194 A1
(43) Pub. Date: Mar. 23, 2017

(54) METHODS FOR BIOMECHANICAL MOVEMENT TRAINING

(71) Applicant: Davinci Corporate Holdings, LLC, Fort Lauderdale, FL (US)

(72) Inventors: Dale Dawson, Davie, FL (US); Michael Gish, Fort Lauderdale, FL (US)

(73) Assignee: Davinci Corporate Holdings, LLC

(21) Appl. No.: 15/273,915

(22) Filed: Sep. 23, 2016

Related U.S. Application Data
(60) Provisional application No. 62/222,596, filed on Sep. 23, 2015.

(51) Int. Cl. G09B 19/00; A63B 69/38; A63B 60/46; A63B 69/00

(52) U.S. Cl. CPC G09B 19/0038; A63B 69/0002; A63B 69/0028; A63B 69/0071; A63B 69/38; A63B 69/00; A63B 60/46; A63B 2069/0008; A63B 2220/805; A63B 2220/80; A63B 2220/40; A63B 2220/30

(57) ABSTRACT

The present invention advantageously provides a movement training device, including a base configured to attach to a user's body; a movement guide coupled to the base, wherein the movement guide defines an elongated malleable body; and a contact element coupled to the movement guide.

### CROSS-REFERENCE TO RELATED APPLICATION

This application is related to and claims priority to U.S. Provisional Patent Application Ser. No. 62/222,596, filed Sep. 23, 2015, entitled BIOMECHANICAL MOVEMENT TRAINING DEVICE, the entirety of which is incorporated herein by reference.

### STATEMENT REGARDING FEDERALLY SPONSORED RESEARCH OR DEVELOPMENT

n/a

### FIELD OF THE INVENTION

The present invention relates to systems and methods of use thereof for training, aiding, and/or selectively restricting patterns of movement for an individual.

### BACKGROUND OF THE INVENTION

Many physical activities require wide ranges of coordination between numerous part of an individual's body, whether coordinating the seemingly innocuous movement of your feet and legs through ankle, knee, and hip joints when taking a walk, or coordinating the relative motion and twist rate between your shoulder, upper arm, elbow, wrist and hand during a golf swing. It is often difficult to assess or improve such movement coordination through just visual observation alone, and although expensive biomechanical video analysis equipment exists, such equipment and facilities are often only accessible to highly paid athletes and their organizations. Systems and methods of use thereof that provide an individual with low-cost, immediate tactile, visual, and/or other sensory feedback during coordinated patterns of movement are desirable.

### SUMMARY OF THE INVENTION

The present invention advantageously provides a movement training device, including a base configured to attach to a sports equipment item; a movement guide coupled to the base, wherein the movement guide defines an elongated malleable body; and a contact element coupled to the movement guide. The contact element may include a substantially spherical ball and/or may define at least one of a semi-circular, conical, and frustro-conical shape. The contact element may be electrically conductive, the movement guide may be malleable in a plurality of geometric planes, and/or the movement guide may be releasably secured to the base. A length of the movement guide may be selectively adjustable. The base may include one or more openings to receive a portion of the sports equipment item therein. The sports equipment item may include at least one of a golf club, tennis racquet, and baseball bat. The device may include a sensor coupled to the contact element, where the sensor is configured to detect when the contact element contacts a portion of a user. The sensor may include one of an electrical resistance sensor, an electrical inductance sensor, and an optical sensor. The device may include an accelerometer coupled to at least one of the base, movement guide, and contact element.

A movement training device is provided, including a base configured to attach to a sports equipment item; a first movement guide coupled to the base, wherein the first movement guide defines an elongated malleable body; a first contact element coupled to the first movement guide; a second movement guide coupled to the base, wherein the second movement guide defines an elongated malleable body; and a second contact element coupled to the second movement guide. The sports equipment item may include at least one of a golf club, tennis racquet, and baseball bat.

A method of movement training for a user is provided, including attaching a movement training device to a sports equipment item, wherein the movement training device includes a base configured to attach to a sports equipment item; a movement guide coupled to the base, wherein the movement guide defines an elongated malleable body; and a contact element coupled to the movement guide; the method further including manipulating a geometrical configuration of the movement guide in one or more geometrical planes such that the contact element contacts a portion of the user at one or more points along a range of motion of the user; and moving through the range of motion while performing at least one of (i) avoiding contact between the contact element and the portion of the user along substantially the entire range of motion, (ii) achieving contact between the contact element and the portion of the user at one or more points along the range of motion, and (iii) maintaining contact between the contact element and the portion of the user along substantially the entire range of motion. The range of motion may include at least one of a golf club swing, a tennis racquet swing, and a baseball bat swing. The sports equipment item may include at least one of a golf club, tennis racquet, and baseball bat. The movement training device may generate at least one of an audible, visual, and tactile alert when moving through at least a portion of the range of motion. The method may include electronically transmitting at least one of speed information, location information, and range of motion information from the movement training device to a computing device.

A movement training device is provided, including a base configured to attach to a portion of a user's body; a movement guide coupled to the base, wherein the movement guide defines an elongated malleable body; and a contact element coupled to the movement guide. The contact element may include a substantially spherical ball and/or may define at least one of a semi-circular, conical, and frustro-conical shape. The contact element may be electrically conductive, the movement guide may be malleable in a plurality of geometric planes, and/or the movement guide may be releasably secured to the base. A length of the movement guide may be selectively adjustable. The base may include one or more openings to receive the portion of the user's body therein. The portion of the user's body may include at least one of an arm, leg, and waist. The device may include a sensor coupled to the contact element, where the sensor is configured to detect when the contact element contacts a portion of a user. The sensor may include one of an electrical resistance sensor, an electrical inductance sensor, and an optical sensor. The device may include an accelerometer coupled to at least one of the base, movement guide, and contact element.

A movement training device is provided, including a base configured to attach to a portion of a user's body; a first movement guide coupled to the base, wherein the first movement guide defines an elongated malleable body; a first contact element coupled to the first movement guide; a second movement guide coupled to the base, wherein the second movement guide defines an elongated malleable body; and a second contact element coupled to the second movement guide. The portion of the user's body may include at least one of an arm, leg, and waist.

A method of movement training for a user is provided, including attaching a movement training device to a portion of the user's body, wherein the movement training device includes a base configured to attach to the portion of the user's body; a movement guide coupled to the base, wherein the movement guide defines an elongated malleable body; and a contact element coupled to the movement guide; the method further including manipulating a geometrical configuration of the movement guide in one or more geometrical planes such that the contact element contacts one or more portions of the user at one or more points along a range of motion of the user; and moving through the range of motion while performing at least one of (i) avoiding contact between the contact element and the one or more portions of the user along substantially the entire range of motion, (ii) achieving contact between the contact element and the one or more portions portion of the user at one or more points along the range of motion, and (iii) maintaining contact between the contact element and the one or more portions of the user along substantially the entire range of motion. The range of motion may include at least one of a golf club swing, a tennis racquet swing, a baseball bat swing, shooting a basketball, throwing a baseball, throwing a football, running, and jumping. The portion of the user's body may include at least one of an arm, leg, and waist. The movement training device may generate at least one of an audible, visual, and tactile alert when moving through at least a portion of the range of motion. The method may include electronically transmitting at least one of speed information, location information, and range of motion information from the movement training device to a computing device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an example of a biomechanical movement pattern training device constructed in accordance with the principles of the present invention;

FIG. 2 is another illustration of an example of a component of a biomechanical movement pattern training device constructed in accordance with the principles of the present invention;

FIG. 3 is another illustration of an example of a component of a biomechanical movement pattern training device constructed in accordance with the principles of the present invention;

FIG. 4 is an illustration of an example of a biomechanical movement pattern training device constructed in accordance with the principles of the present invention;

FIG. 5 is an illustration of another example of a biomechanical movement pattern training device constructed in accordance with the principles of the present invention;

FIG. 6 is an illustration of another example of a biomechanical movement pattern training device constructed in accordance with the principles of the present invention and coupled to sports equipment;

FIG. 7 is an illustration of yet another example of a biomechanical movement pattern training device constructed in accordance with the principles of the present invention and coupled to sports equipment;

FIG. 8 is another illustration of the biomechanical movement pattern training device shown in FIG. 7;

FIG. 9 is an illustration of another example of a biomechanical movement pattern training device constructed in accordance with the principles of the present invention and coupled to sports equipment;

FIG. 10 is an illustration of another example of a biomechanical movement pattern training device constructed in accordance with the principles of the present invention and coupled to a user's body;

FIG. 11 is another illustration of an example of a biomechanical movement pattern training device constructed in accordance with the principles of the present invention and coupled to a user's body;

FIG. 12 is an illustration of another example of a biomechanical movement pattern training device constructed in accordance with the principles of the present invention and coupled to a user's body; and

FIG. 13 is another illustration of an example of a biomechanical movement pattern training device constructed in accordance with the principles of the present invention and coupled to a user's body.

### DETAILED DESCRIPTION OF THE INVENTION

The present disclosure provides improved systems and methods of use thereof that provide an individual with immediate tactile, visual, and/or other sensory feedback during coordinated patterns of movement that can be used for sports training, occupational or other physical therapy/rehabilitation programs, and other areas where it is desirable to improve and/or alter coordinated patterns of movements. In particular, the present disclosure provides example of biomechanical movement training devices that aid in analyzing and modifying various ranges of motion and coordination of one or more body parts and/or in conjunction with one or more pieces of sporting or physical therapy equipment.

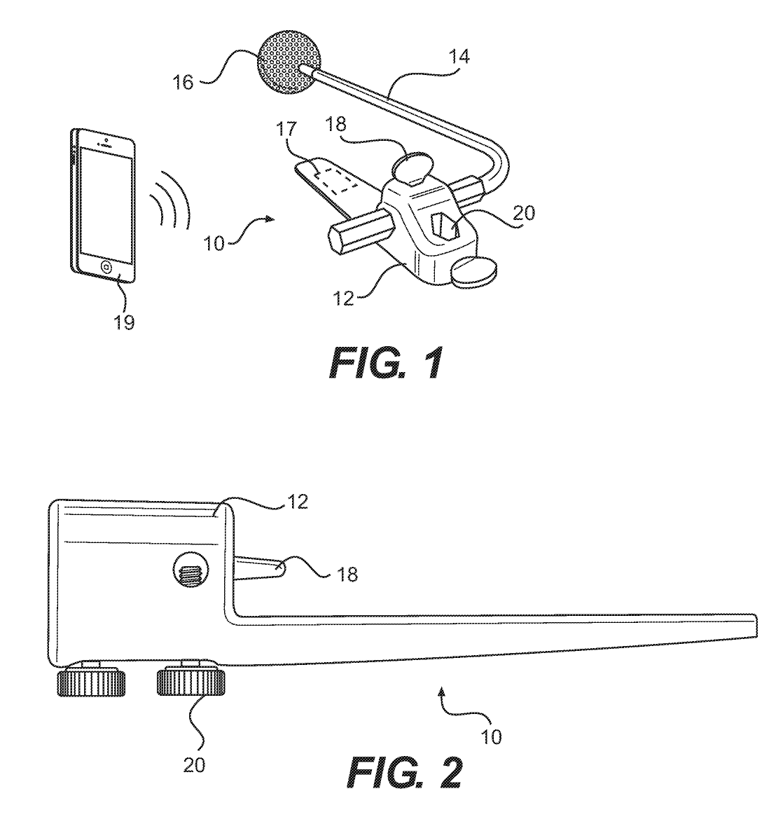

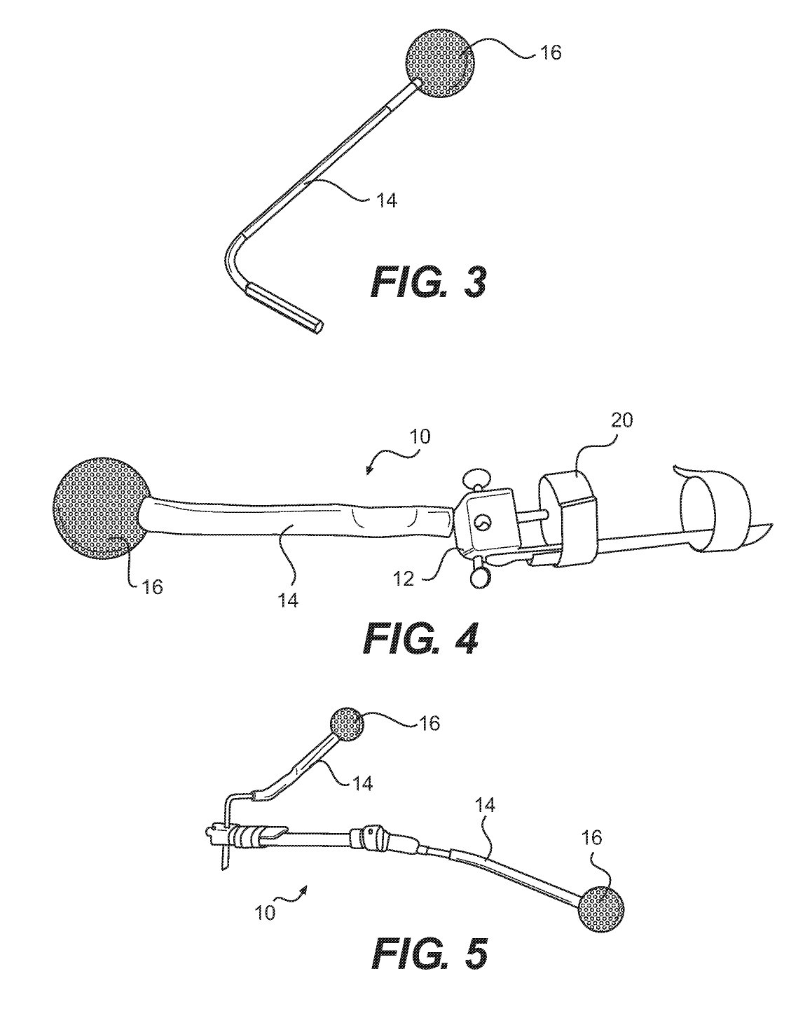

Turning now to FIGS. 1-4, examples of a biomechanical movement training device 10 are generally shown. The device 10 generally includes a frame or base 12 that facilitates coupling or connecting the device to one or more pieces of sporting or physically therapeutic equipment, as well as additional components of the device 10. The base 12 may be constructed from metals, polymers, plastics, or combinations and variations thereof, and may take on varying shapes and dimensions to provide the features and uses described herein.

The device may also include one or more movement guide(s) 14 coupled to the base 10. The examples in FIGS. 1-4 illustrate a single movement guide 14, while FIG. 5 illustrates an example of a device 10 with multiple movement guides 14. The movement guide(s) 14 are generally positionable about a person's body or a sports equipment item to define a feedback position or point where the designated portion of the body comes into contact with a portion of the device 10. The movement guide(s) 14 may include an elongated body with a first portion or end that is releasably securable to the base, and may further include a second portion or end that is positionable about the user's body. The second end or portion may include a contact element 16 in the form of an expanded ball, sphere, or other shape (including but not limited to conical, triangular, frustro-conical, and/or curvilinear shapes to conform to or compliment a particular anatomical shape) that contacts the person's body. The contact element 16 may have larger dimensions compared to the movement guide 14. The elongated body of the movement guide 14 may be malleable or bendable in multiple geometric planes, may have one or more telescoping or other length-adjustable mechanisms, and/or may otherwise have a shape that is modifiable or selectively configurable by a user to conform to the desired dimensions or anatomical portions of the person using the device 10 and/or to set the desired range of motion for analysis and feedback. The contact element 16 may be constructed from various plastics, polymers, and/or metals (or combinations thereof) to provide the features and operation described herein. The contact element may also include foam, padding, and/or one or more layers of shock-absorbing material.

The device 10 may include one or more electronic components, sensors, and/or other audio, video, and/or tactile components (collectively referred to as “feedback components 17”), to indicate to a user when the contact element is in contact with (or within a designated space from) the user's body, and/or to record one or more aspects of the use of the device 10 and any associated data therewith. The feedback components 17 or portions thereof may be coupled to and/or embedded in the base 12, the movement guide 14, and/or the contact element 16, and may enable complementary use and/or analysis through the use of an “app” or other software. For example, the device 10 and/or feedback components 17 may be configured to wirelessly transmit information or data to an external computing device 19, such as a smart phone, tablet, PDA, laptop computer, or the like for recording and analysis of the use of the device 10.

The contact element 16 may be electrically conductive or inductive and/or be in communication with a speaker or buzzer to provide an audible alert when in contact with the user's body. In an alternative example, the device 10 may generate an alert via the feedback components 17 when a portion of the device 10, such as the contact element 16, is in contact or proximity to a reactive pad or sensor attached to the user's body. As another example, the device 10 may include a short range laser or other optical component on one or more portions thereof to directly measure or deduce the distance of the contact element 16 from the user or an object placed on the ground, on a wall, or other point providing location measurements or calculations in conjunction with the training device. In another example, the feedback components 17 of the device 10 may include one or more accelerometers or other sensors to record aspects of the movement of the device 10.

The movement guide(s) 14 may be removably insertable into one or more openings in the base to provide a selectable positionable and releasable fit with the base 12. The movement guide(s) 14 may be releasably secured to the base 12 through the use of one or more fasteners or other securing elements 18, such as a lock screw, clamp, set pin, or the like.

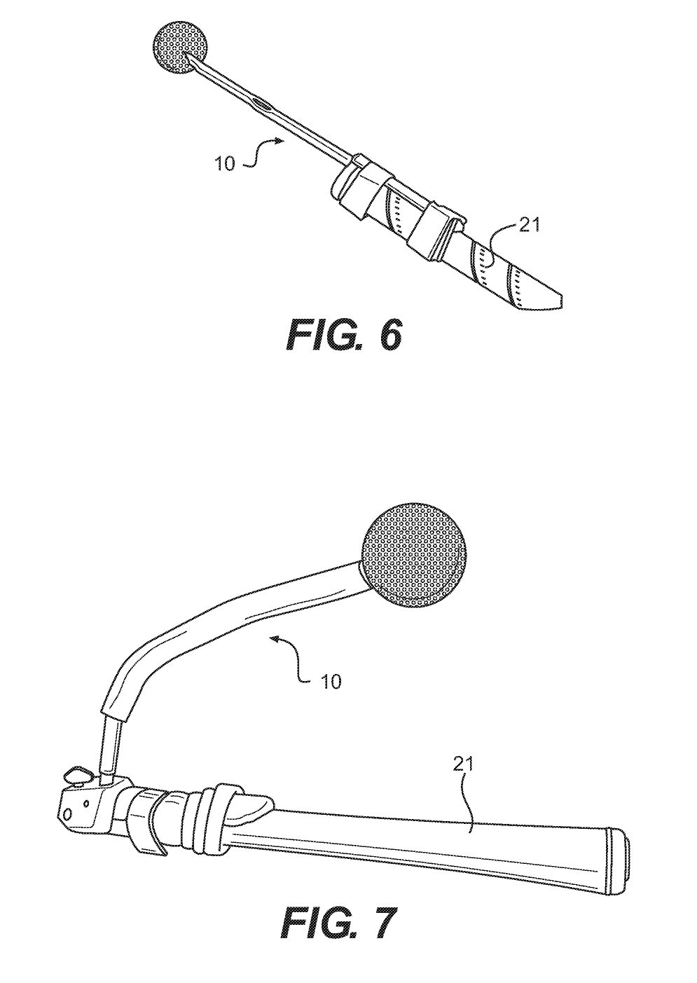

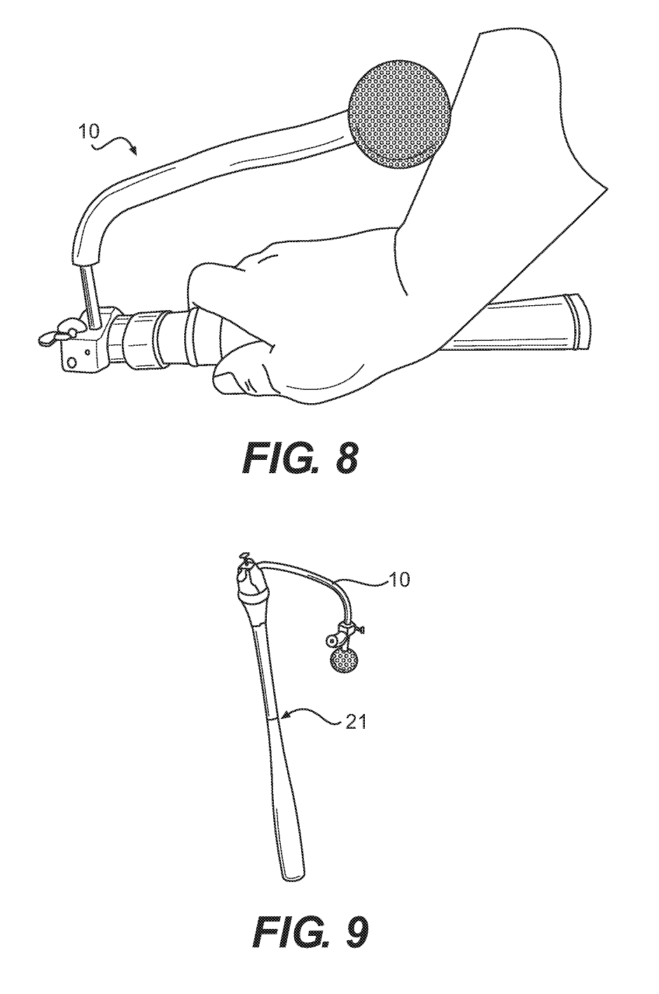

As shown in FIGS. 4 and 6-9, the base 12 may also include one or more fasteners, clamps, connectors, opening, protrusions, or the like 20 to facilitate attachment of the device 10 to sporting or rehabilitative equipment, and/or directly to portions of a user's body. For example, FIG. 4 shows an example of the device 10 with straps that allow the device 10 to be attached to a person's body, such as their arm, leg, or portion thereof. FIGS. 6-7 illustrate examples of the device 10 coupled to a gold club, FIG. 8 is an illustration of an example of a device 10 coupled to a racket handle, and FIG. 9 shows an example of a device 10 coupled to a baseball bat. Use of the device 10 is contemplated with virtually any sporting or rehabilitative equipment, including but not limited to the aforementioned examples, as well as with hockey sticks, billiards cues, lacrosse sticks, etc.

In an exemplary use of the device 10, the base 12 may be coupled either to a piece of sports equipment 21 or to a portion of a person's body 23, such as the arm, leg, or otherwise. Once the base 12 is secured in position, the movement guide 14 may be physically manipulated to place the contact element 16 into a desired position against another portion of the body to guide and/or obstruct the particular portion of the person's body through a particular range of motion.

For example, the user may attach the device 10 to a golf club, and then position the contact element 16 against a portion of the wrist or forearm to act as a physical guide for movement in one or more planes. The user would then progress through their golf swing, with the contact element 16 providing tactile feedback by either preventing the user's body part from departing from the desired range of motion, or by providing the user with a feel of where to limit their motion and/or otherwise coordinate their movement in conjunction with maintaining contact with the contact element 16. The device 10 may be configured for use with a variety of sports equipment items, including, for example, baseball or cricket bats; tennis, squash, or badminton racquets; hockey sticks; lacrosse sticks; and the like.

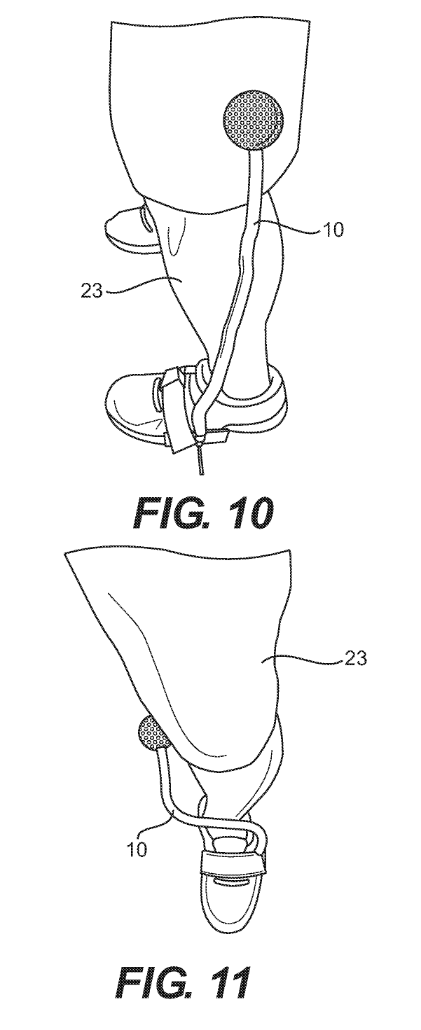

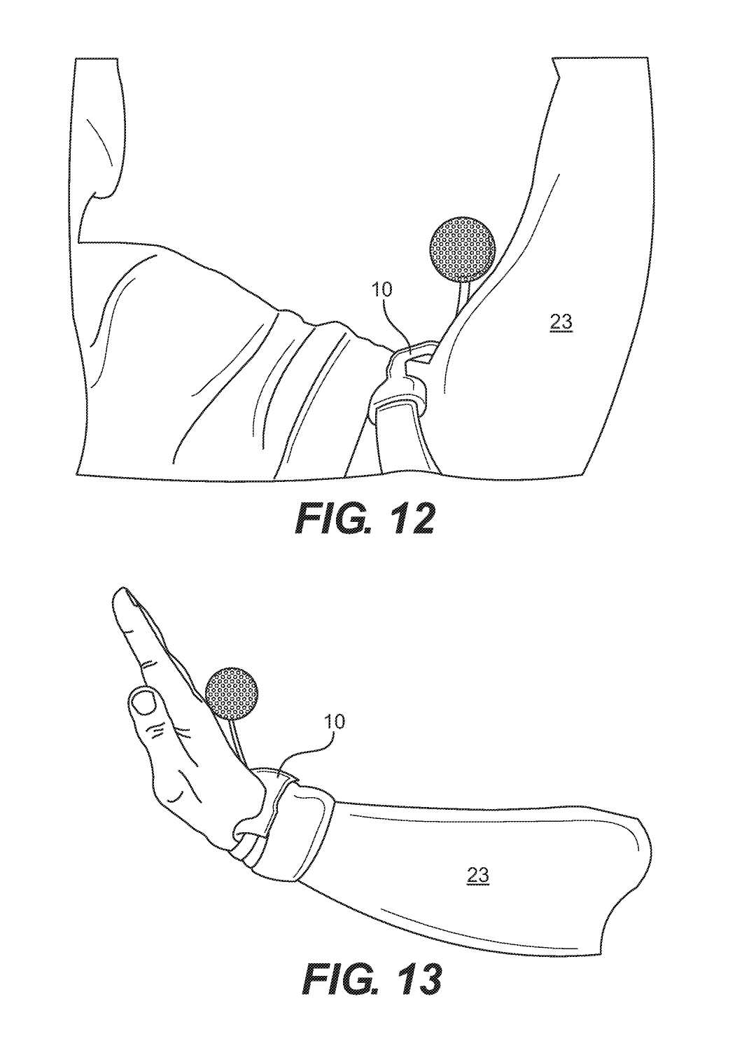

In an alternative example without external sports equipment, the training device may be used to establish a coordinated movement between multiple segments of a person's body—such as for a quarterback holding a football during a dropback pass play. In such an example, a first portion of the device 10 (such as the base 12, for example) may be attached or secured to a first portion of the person's body, such as the forearm. The contact element 16 may then be manipulated into position into contact or substantial proximity to another portion of the user's body, such as the bicep or upper arm. The user could then train with the device 10 guiding a desired static arm position of holding the football up high with the elbow at a desired angle to facilitate a faster throw and/or release of the football. Many other biomechanical movements can similarly be improved upon by using the device 10 to provide both visual and tactile feedback through its obstruction, resistance and/or mere contact with certain body parts during the course of a coordinated movement, examples of which are shown in FIGS. 10-13, and include various throwing motions for footballs or baseballs; movements involved in running or jumping; shooting a basketball; and other athletic and/or therapeutic motions.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A movement training device, comprising:
a base configured to attach to a portion of a user's body;
a movement guide coupled to the base, wherein the movement guide defines an elongated malleable body; and
a contact element coupled to the movement guide.

2. The movement training device of claim 1, wherein the contact element includes a substantially spherical ball.

3. The movement training device of claim 1, wherein the contact element defines at least one of a semi-circular, conical, and frustro-conical shape.

4. The movement training device of claim 1, wherein the contact element is electrically conductive.

5. The movement training device of claim 1, wherein the movement guide is malleable in a plurality of geometric planes.

6. The movement training device of claim 1, wherein the movement guide is releasably secured to the base.

7. The movement training device of claim 1, wherein a length of the movement guide is selectively adjustable.

8. The movement training device of claim 1, wherein the base includes one or more openings to receive the portion of the user's body therein.

9. The movement training device of claim 1, wherein the portion of the user's body includes at least one of an arm, leg, and waist.

10. The movement training device of claim 1, further comprising a sensor coupled to the contact element, wherein the sensor is configured to detect when the contact element contacts a portion of the user.

11. The movement training device of claim 10, wherein the sensor is one of an electrical resistance sensor, an electrical inductance sensor, and an optical sensor.

12. The movement training device of claim 1, further comprising an accelerometer coupled to at least one of the base, movement guide, and contact element.

13. A movement training device, comprising:
a base configured to attach to a portion of a user's body;
a first movement guide coupled to the base, wherein the first movement guide defines an elongated malleable body;
a first contact element coupled to the first movement guide;
a second movement guide coupled to the base, wherein the second movement guide defines an elongated malleable body; and
a second contact element coupled to the second movement guide.

14. The movement training device of claim 13, wherein the portion of the user's body includes at least one of an arm, leg, and waist.

15. A method of movement training for a user, comprising:
attaching a movement training device to a portion of the user's body, wherein the movement training device comprises:
a base configured to attach to the portion of the user's body;
a movement guide coupled to the base, wherein the movement guide defines an elongated malleable body; and
a contact element coupled to the movement guide;
manipulating a geometrical configuration of the movement guide in one or more geometrical planes such that the contact element contacts one or more portions of the user at one or more points along a range of motion of the user; and
moving through the range of motion while performing at least one of (i) avoiding contact between the contact element and the one or more portions of the user along substantially the entire range of motion, (ii) achieving contact between the contact element and the one or more portions portion of the user at one or more points along the range of motion, and (iii) maintaining contact between the contact element and the one or more portions of the user along substantially the entire range of motion.

16. The method of claim 15, wherein the range of motion includes at least one of a golf club swing, a tennis racquet swing, a baseball bat swing, shooting a basketball, throwing a baseball, throwing a football, running, and jumping.

17. The method of claim 15, wherein the portion of the user's body includes at least one of an arm, leg, and waist.

18. The method of claim 15, wherein the movement training device generates at least one of an audible, visual, and tactile alert when moving through at least a portion of the range of motion.

19. The method of claim 15, further comprising electronically transmitting at least one of speed information, location information, and range of motion information from the movement training device to a computing device.
